(19) United States
(12) Patent Application Publication
(10) Pub. No.: US 2026/0330829 A1
(43) Pub. Date: Oct. 22, 2026

(54) Method for Carrying out a Test Assembly of a Test Part to Be Mounted on a Vehicle Body

(71) Applicant: Bayerische Motoren Werke Aktiengesellschaft, Muenchen (DE)

(72) Inventors: Ismail DEDEMEN, Muenchen (DE); Huu Tuan NGUYEN, Debrecen (HU)

(21) Appl. No.: 19/106,690

(22) PCT Filed: Oct. 26, 2023
(86) PCT No.: PCT/EP2023/079918

§ 371 Date: Feb. 26, 2025

(30) Foreign Application Priority Data
Nov. 17, 2022 (DE) 10 2022 130 411.6

(51) Int. Cl. G06V 20/20; G01M 17/007; G06T 7/33; G06T 7/73

(52) U.S. Cl. CPC G06V 20/20; G01M 17/007; G06T 7/337; G06T 7/74

(57) ABSTRACT

A method for carrying out a test assembly of a test part to be mounted on a vehicle body, comprising: mounting the test part on a receiving section of a reference device; detecting at least one reference pattern arranged or formed in or on the reference device using a detection device of an augmented reality system and generating reference pattern detection information; generating image information, wherein the image information is dependent on the reference pattern information and the image information describes a predefined target state of the test part as well as a target orientation and/or target position of the test part relative to the reference device and is output as visually perceptible information at an output unit of the augmented reality system.

### BACKGROUND AND SUMMARY

This disclosure relates to a method for carrying out a test assembly of a test part to be mounted on a vehicle body.

Corresponding methods for carrying out a test assembly of a test part to be mounted on a vehicle body are fundamentally known from the prior art. However, the systems known therein are distinguished in that they do not have sufficient accuracy in the detection of the position and alignment of a real object and the projection resulting therefrom of information in relation to the position and alignment of an augmented reality system. Conditions on a part or an assembly which are present “randomly” there, for example, screw holes or edges, are typically used as references. However, in many cases these references are not accurate enough or are not in a sufficient quantity to display an assessment by a superposition of information on a display unit to the image shown thereon of the real live detected object in a sufficient accuracy.

This disclosure is based on an object of specifying a method which, in particular with regard to a simple and rapid and cost-effective measure, increases the quality of a test assembly and in particular the assessment of a test assembly of a test part to be mounted on a vehicle body.

This disclosure relates to a method for carrying out a test assembly of a test part to be mounted on a vehicle body, having the following method steps. (A) Mounting the test part on a receptacle section of a reference device. A receptacle section can be understood as a point of the reference device which is designed for the mounting of a part corresponding to the test part, in particular at least one receptacle recess of the receptacle section and/or at least one fastening interface of the receptacle section is designed or formed in such a way that a part corresponding to the test part is attachable. In the attached status of the test part on the reference device. (B) At least one reference pattern arranged or formed in or on the reference device is detected using a detection device of an augmented reality system and reference pattern detection information is generated. The reference pattern is in this case, for example, a pattern deliberately designed for the reference finding or referencing and thus for tracking of the augmented reality system. This can be distinguished in that it has reliable detectability of its position and alignment relative to a detection device of the augmented reality system. (C) After the reference pattern has been detected and therefore reference pattern detection information has been generated, image information is generated, wherein the image information depends on the reference pattern information and the image information describes a predefined target status of the test part and a target alignment and/or target position of the test part relative to the reference device and is output as visually perceptible information on an output unit of the augmented reality system.

For example, a representation of the test part which is transparent at least in some sections and/or opaque at least in some sections is output or displayed on the output unit, for example, a display of the augmented reality system. In that the reference detection information reflects the position and alignment of the augmented reality system and in particular also, during a change of the position and/or alignment of the augmented reality system relative to the reference device, detects and provides this change, the image information or the display of the target part, for example, a so-called ghost model of the target part, can be adapted on a display of the augmented reality system so that the target part is displayed as attached on the reference device. It is therefore made possible, even with a change of the observation angle or a change of the detection angle of the ARS (augmented reality system)-side detection to the reference device, to display a representation on the display of the augmented reality system on which the target part of the image information is represented as “remaining” on the receptacle section.

A CAD data set of the test part, which describes the target status of the test part, can be stored in a computer system. Furthermore, a CAD data set of the reference device can be stored in the computer system, which describes the target status of the reference device. It is also possible that a CAD data set of the assembled status of test part and reference device is stored in the computer system, which describes the target status of an installed assembly consisting of test part and reference device. This information from corresponding CAD data sets can be used to generate the image information and represent a displayed target alignment and/or target position and/or a displayed target status of the test part. In other words, for example, the target status of the test part and/or the target alignment of the test part relative to the reference device and/or the target position of the test part relative to the reference device can be inferred or derived, for example, from the CAD data set of the assembled status.

The reference pattern can be designed in such a way that it is suitable for at least two-dimensional, preferably three-dimensional, referencing or tracking.

The augmented reality system can be designed, for example, as a tablet and/or glasses and/or a smart phone and/or a portable computer (for example, a laptop). The augmented reality system can also be designed as a mobile terminal, for example, as a portable electronic terminal or as an electronic mobile device. For example, an electronic terminal, e.g., a smart phone, a tablet computer, and/or a portable computer (for example, a laptop), can be used as the augmented reality system.

Preferably, the reference device can comprise at least two reference patterns on the reference device, in particular on a reference component of the reference device. It is possible that the reference device comprises at least two reference patterns arranged separate or spaced apart from one another, wherein their area differs at least by a factor of 2, preferably a factor of 3, particularly preferably a factor of 4, highly preferably a factor of 5, more preferably a factor of 6.

The reference device can be designed, for example, as a so-called zero body, also referred to as a test cubing body or zero geometry body or masterpiece body, thus an assembly which reflects a target status of an assembly, for example, a vehicle body and/or vehicle interior. Therefore, for example, a part as a component part of a reference device forming a reference assembly and consisting of multiple reference components can be removed and therefore the receptacle section of the reference device can be released to receive the test part to be mounted, so that the test part can be mounted on the receptacle section. In other words, the test part is temporarily attached in or on the receptacle of the reference device and a quality assessment of the test part is assessed, assisted by the augmented reality system, and it is then removed or detached again from the receptacle of the reference device.

It is possible that at least two reference patterns, in particular at least two groups of reference patterns, are arranged or formed on the reference device, wherein the respective reference pattern or the respective reference pattern groups are assigned to different focus regions for focusing a section of the reference device. Thus, for example, an extensive reference pattern can be configured to detect a detection of a large image area of the reference device. In other words, using an extensive reference pattern, a larger area section of the reference device can be detected simultaneously by the detection device of the augmented reality system and displayed by the display unit of the augmented reality system and at the same time enable a sufficient accuracy of the visible image section. This is suitable for the display and possibly the assessment of test (component) parts having a large extension (e.g., greater than 10.0 cm, preferably greater than 25.0 cm, particularly preferably greater than 50.0 cm, more preferably greater than 100.0 cm). A second reference pattern, in particular a second group of reference patterns, can be distinguished by a smaller area and/or by a smaller maximum extension in comparison to the larger area sections and can be used to execute focusing of the detection device on smaller-area sections of the reference device.

It can therefore be advantageous if reference patterns or reference pattern groups adapted to the respective focus regions are arranged or formed on predefined focus regions, so that depending on the selection of the predefined focus region, the reference patterns assigned thereto and possibly adapted thereto can be used for the detection and in particular for the tracking. The executed tracking comprises updating of the depicted image information, which runs at the same time or takes place online, using the image of the real object detected via the detection device of the augmented reality system and displayed on the augmented reality system, thus of the test part and in particular of the areas of the reference device adjacent to the test part. The tracking can therefore be understood as dynamic tracking of the image information displayed on the display device to an observation section of the test part and/or the reference device, which changes due to the movement of the augmented reality system in space.

It is possible that the image information describes a target status of the reference device. Therefore, the image information can represent, for example, a reference component of the reference device and/or at least one alignment and/or positioning of two reference components of the reference device visually on the display unit, i.e., for example, on a display, of the augmented reality system.

The at least one reference pattern can be formed, for example, as an element existing separately from the reference device and/or the test part and can be fastened or fastenable in a friction-locked and/or materially-bonded and/or formfitting manner on the reference device and/or on the test part. The reference pattern can thus be formed, for example, as a rigid plate, which forms a pattern, for example, by way of raised or recessed sections. The reference pattern can be designed, for example, as a sticker which is glued or can be glued on the reference pattern. The at least one reference pattern can have a form which is flat or is raised in some sections. Alternatively or additionally, the reference pattern can have a contrasted structure, or a contrast due to the selection of different colors and/or different degrees of brightness and/or different degrees of gloss of individual sections of the reference pattern can form a reference pattern which is detectable rapidly and reliably by the detection device of the augmented reality system. The augmented reality system is configured such that it recognizes a reference pattern which is predefined, in particular unique, in its structure (e.g., brightness and/or gloss and/or color). The augmented reality system is preferably configured to assign the detected reference pattern to a predefined reference pattern stored in a data memory of the augmented reality system. Due to this assignment, a predefined focus or image area of the reference device and/or a test part and/or a receptacle recess of the reference device can be identified. This identification or identification information formed therefrom can be used to change, in particular to make more specific, an output of image information, in particular information on the status and/or the position and/or the alignment of a target test part.

At least one reference pattern can be integrally formed with the reference device, for example. The reference pattern is preferably incorporated into a surface of the reference device as a depression and/or as a protrusion. For example, at least one reference pattern can be milled at least in some sections, in particular completely, into the surface of the reference device and/or a test part. Alternatively or additionally, the at least one reference pattern can be arranged or formed at least in some sections, preferably predominantly, particularly preferably entirely, by a 3D printing method on the reference device, for example, printed/fused thereon. For example, the reference component or at least one component part thereof is produced in the course of a 3D printing method and therefore also formed in situ during the production process. A 3D printing method can be understood, for example, as an additive manufacturing method using a metallic powder or a powder made of plastic, for example, a selective laser melting method.

At least one reference pattern can have an area, for example, which is at least 2 cm², preferably at least 5 cm², particularly preferably at least 10 cm², highly preferably at least 100 cm², more preferably at least 250 cm². An area of the at least one reference pattern in this case means a planar extension within which defined patterns or defined structures are formed, which are detected by the detection device and are used to form the reference pattern detection information or to generate the image information describing the target status of the test part and the target alignment and the target position of the test part relative to the reference device.

The reference pattern can, for example, be three-dimensionally formed and can have a depth of 1.5 mm to 5.0 mm and the highest possible contrast (for example, first sections in white or silver color and further sections in dark gray or black color).

At least one reference pattern can have, for example, an area of at most 1000 cm², preferably at most 500 cm², particularly preferably at most 250 cm², highly preferably at most 100 cm², more preferably at most 25 cm². Such large areas of the reference pattern enable a large image detail to be detected by the detection device. Preferably, at least one reference pattern can have a rectangular and/or a square outer boundary shape and/or an outer boundary shape of a regular n-polygon (e.g., pentagon, hexagon, heptagon, or octagon, etc.).

The reference pattern can have, for example, an optically detectable structure for detection by the detection device of the augmented reality system and for generating the image information, which has an accuracy of at least 1.0 mm, preferably of at least 0.5 mm, particularly preferably of at least 0.25 mm, highly preferably of at least 0.1 mm. This means that a deviation of a nominal measure from an actual measure of the structure of the reference pattern deviates at most by the abovementioned values (in shape and/or location), thus at most, for example, by 1.0 mm or 0.5 mm.

At least one reference pattern can have a depth, for example, i.e. a protrusion or depression perpendicular to its main extension plane, of at most 20 mm, preferably at most 10 mm, particularly preferably at most 5 mm, highly preferably at most 3 mm, and/or can have a depth of at least 0.25 mm, preferably at least 0.35 mm, particularly preferably at least 0.5 mm, highly preferably at least 1.0 mm.

It is optionally possible that the at least one reference pattern comprises at least three defined depth regions, thus at least three areas detectable in a depth-defined or depth-specific manner in three levels by the detection device of the augmented reality system. In other words, at least three area sections of the reference pattern are arranged or formed at different distances perpendicular to the main extension plane of the reference pattern such that via the detection device of the augmented reality system, the respective area sections and the relative depth assigned thereto are detectable in relation to a reference depth and/or in relation to one another. A good tracking capability and/or rapid and reliable or accurate generation of image information is enabled via this depth-dependent or depth-specific detectability of individual area sections of the reference pattern. In this case, for example, a first depth region can have a distance from a second depth region and/or a second depth region can have a distance from a third depth region of 0.5 mm to 100 mm, preferably a distance of 1 mm to 50 mm.

It is possible that at least one first reference pattern is arranged or formed on a first part of the reference device and at least one second reference pattern is arranged or formed on a second part of the reference device and the at least one first and the at least one second reference pattern are detected by way of the detection device of the augmented reality system and an evaluation of the position and/or alignment of the first reference pattern relative to the second reference pattern is carried out and reference pattern status information describing the position and/or alignment of the first reference pattern relative to the second reference pattern is generated. This reference pattern status information can be compared, for example, with target status information and corresponding notification information can be output if a deviation exceeding a defined degree is present. Using the detection and evaluation of the position and/or alignment of at least two reference patterns arranged in or on the reference device, a calibration of the reference patterns in relation to one another and/or the augmented reality system can be carried out.

The reference device can optionally be connected, in particular permanently, to a support structure, for example, to an assembly carrier. The assembly carrier can have, for example, at least one reference pattern, so that in particular in regions of the reference device adjacent to the assembly carrier and/or in regions of a test part adjacent to the assembly carrier, an assembly-carrier-side reference pattern can be produced for detecting and determining the position and/or alignment of the augmented reality system relative to the reference device and/or relative to the test part. Because the assembly carrier is not specified or is not specified in the dimensions of its surface by a target shape of a vehicle body, like the reference device itself, it can be advantageous to use assembly-carrier-side reference patterns for tracking the reference device and/or the test part. The assembly carrier can have in this case, for example, a frame structure and can be used to support a reference device, in particular a reference device designed as a vehicle body. In that the assembly carrier has a defined position and/or alignment, which is unchanging in intended use, relative to the reference device, in particular to the zero body, at least one assembly-carrier-side reference pattern can be used for the relative position and/or alignment determination, i.e. for the tracking of the reference device and/or the test part in the case of an augmented reality system moved relative thereto.

For example, at least one reference pattern can have at least three reference planes as depth regions, wherein a second depth region has a distance from a first depth region in the range of 1.0 mm to 10.0 mm. Optionally, a third depth region can have a distance from the first depth region of 10.01 mm to 30.0 mm. For example, a fourth depth region can also have a distance from the first depth region of 30.01 mm to 100.0 mm.

In a preferred embodiment, the method provides that an assessment of a test part is to take place in conjunction with its installation location on a higher-order assembly or a higher-order part. For this purpose, initially a test region is determined, i.e. it is defined at which location of the reference device which part, thus the test part, is to be judged or assessed. For this purpose, the surroundings of the test part on the reference device are also observed, in particular reference patterns which are obvious or are required for the desired observation accuracy and the image detail or focus resulting therefrom. Furthermore, CAD data are used, which contain the target status and the target position and/or target alignment of the test part relative to the reference device.

Furthermore, an automatic selection and/or determination of existing reference patterns adjoining the test part to be assessed can be carried out. The selected or determined information is then provided to the augmented reality system or augmented reality software for further processing. This information is used for tracking or referencing and therefore for following the position and/or alignment of the augmented reality system relative to the reference patterns. Finally, test parts and/or regions thereof to be judged are represented, in particular in the form of target and/or actual lines and/or edges and/or areas. Finally, a simplified geometric assessment of the test part and/or the assembly, comprising the test part and the reference device, can be carried out on the basis of this visually perceptible image information.

In addition to the method for carrying out a test assembly of a test part to be mounted on a vehicle body, the disclosure also relates to an arrangement comprising a test part and a reference device as well as an augmented reality system, wherein the arrangement is configured to carry out a method described herein.

All advantages, details, embodiments, and/or features of the method according to the disclosure are transferable or are to be applied to the arrangement according to the disclosure.

### BRIEF DESCRIPTION OF THE DRAWINGS

This disclosure is explained in more detail on the basis of exemplary embodiments in the drawings.

FIG. 1 shows a schematic illustration of an augmented reality system, which is directed onto a reference device equipped with a test part, according to an exemplary embodiment; and,

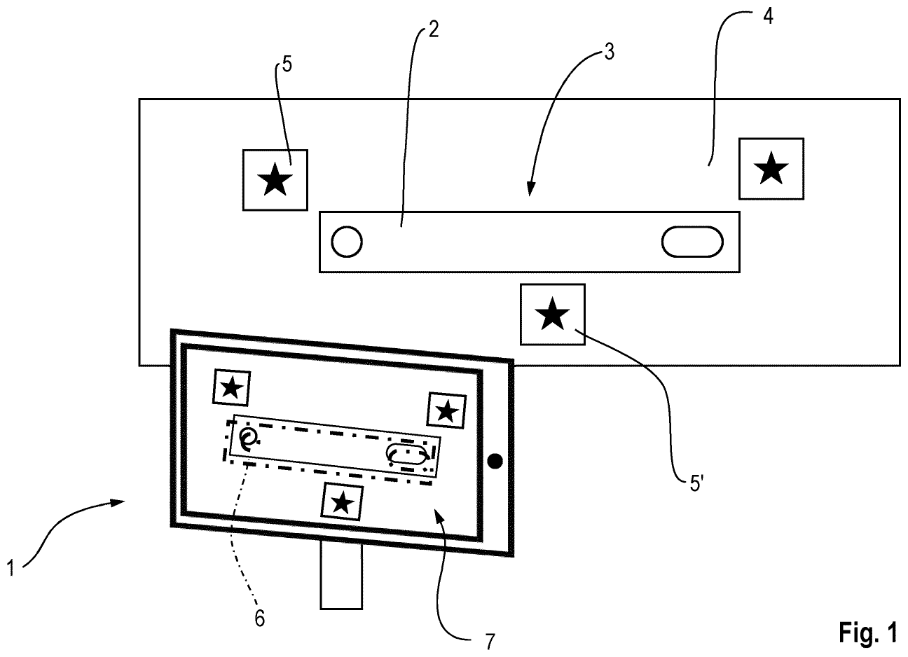

FIG. 2 shows a schematic illustration of a reference device provided with reference patterns according to an exemplary embodiment.

### DETAILED DESCRIPTION OF THE DRAWINGS

In the figures, individual elements for performing a method for carrying out a test assembly of a test part 2 to be mounted on a vehicle body are shown. The system and method disclosed herein may comprise, or be carried out by software stored in a memory, and a processor configured to execute the software.

The method provides the following method steps in this case (A) Mounting the test part 2 on a receptacle section 3 of a reference device 4, in this case the test part 2 can be fastened by way of fasteners (not shown), e.g., screws, snap lugs and/or catch lugs and/or rivets, detachably or not detachably nondestructively on a receptacle section 3 of the reference device 4. (B) At least one reference pattern 5 arranged or formed in or on the reference device 4 is then detected using a detection device of an augmented reality system 1 and reference pattern detection information is generated. (C) Then, image information 6 is generated, wherein the image information 6 depends on the reference pattern information and the image information 6 describes a predefined target status of the test part 2 and a target alignment and/or target position of the test part 2 relative to the reference device 4 and is output as visually perceptible information on an output unit 7 of the augmented reality system 1. The detection of the reference pattern 5 can be used here for tracking image information 6 displayed at the augmented reality system 1 on its output unit 7. The image information 6 can be output, for example, on an output unit 7 designed as a display screen, which is configured to output image information in a form visually perceptible to a human. For example, the output unit 7 is designed as a display screen and/or as a projector. The projector can be configured here to project image information on a wall and/or on an object and/or on a retina and/or on a spectacle lens and therefore to output it so it is visually perceptible for a user.

The image information 6 can describe a target status of the reference device 4. The image information 6 can thus visually display at least in some sections a region adjacent to the test part 2, for example, as an edge. Therefore, for example, a target gap dimension can be output as image information 6, wherein both delimitation edges forming the gap of the target gap dimension can be displayed in the image information, for example, as ghost structures, i.e., for example, as target structures represented as transparent.

At least one reference pattern 5 can be formed, for example, as an element present separately from the reference device 4 and can be fastened or fastenable in a friction-locked and/or materially-bonded and/or formfitting manner on the reference device 4. Preferably, the reference pattern 5 is fastened permanently, i.e. not detachable nondestructively, on the reference device 4. Alternatively, the reference pattern 5 can be detachably connected to the reference device 4. As an example of a detachable fastening, it can be set forth that the reference pattern 5 is fastened by way of magnetic forces on the reference device 4 and can experience a change in its position and/or alignment if needed.

At least one reference pattern 5 can optionally be integrally formed with the reference device 4. Preferably, the reference pattern 5 is formed or incorporated in a surface of the reference device 4 as a depression and/or as a protrusion. The reference pattern 5 can be formed here such that it is exclusively used for the purpose of detection by the detection device of the augmented reality system 1 and therefore does not possess any further functions, for example, for fastening and/or for guiding and/or centering parts within an assembly process. In other words, the reference pattern 5 is optimized, preferably exclusively, for the purpose of rapid and reliable, in particular three-dimensional, detection of a relative position and/or alignment of an augmented reality system 1 having the detection device and the reference pattern 5 or the reference device 4 bearing the reference pattern 5.

At least one reference pattern 5 can have, for example, an area which is at least 2 cm², preferably at least 5 cm², particularly preferably at least 10 cm², highly preferably at least 100 cm², more preferably at least 250 cm². The area of the reference pattern can be, for example, at most 1000 cm², preferably at most 500 cm², particularly preferably at most 250 cm², highly preferably at most 100 cm², more preferably at most 25 cm².

A reference pattern 5 can comprise, for example, an optically detectable structure for detection by the detection device of the augmented reality system 1 and can be suitable for generating the image information 6, wherein the generated image information has an accuracy of at least 1.0 mm, preferably of at least 0.5 mm, particularly preferably of at least 0.25 mm, highly preferably of at least 0.1 mm.

At least one reference pattern 5 can have, for example, in addition to a planar extension, also an extension going into the depth, thus extending perpendicular to a main extension plane, wherein (a) its depth 8 is at most 20 mm, preferably at most 10 mm, particularly preferably at most 5 mm, highly preferably at most 3 mm, and/or (b) its depth 8 is at least 0.25 mm, preferably at least 0.35 mm, particularly preferably at least 0.5 mm, highly preferably at least 1.0 mm.

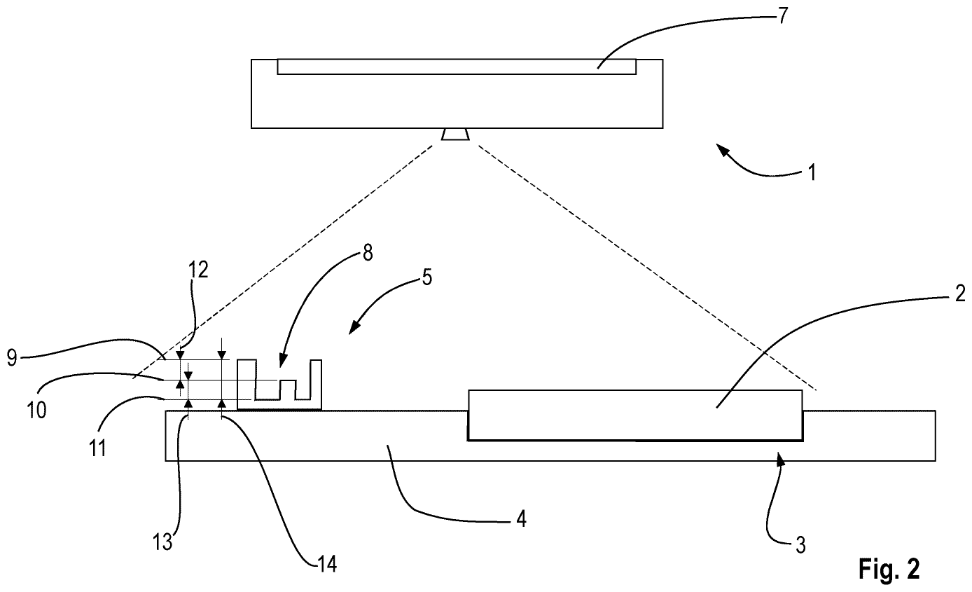

At least one reference pattern 5 can comprise, for example, at least three defined depth regions 9, 10, 11, cf. FIG. 2, a reference pattern 5 is schematically shown therein in a side view, preferably shown as a section. A first depth region 9 can have, for example, a distance 12, 13, 14 of 0.5 mm to 100 mm from a second depth region 10 and/or a second depth region 10 can have such a distance from a third depth region 11. The distance 12, 13, 14 between the depth regions 9, 10, 11 is preferably in each case between 1 mm and 50 mm.

It is possible that a first reference pattern 5 is arranged or formed on a first part of the reference device 4 and a second reference pattern 5′ is arranged or formed on a second part of the reference device 4 and the first and the second reference pattern 5, 5′ are detected by way of the detection device of the augmented reality system 1 and an evaluation of the position and/or alignment of the first reference pattern 5 relative to the second reference pattern 5′ is performed and reference pattern status information describing the position and/or alignment of the first reference pattern 5 relative to the second reference pattern 5′ is generated. A statement about a possible change of the reference device 4 can be made by way of this reference pattern status information. For example, because of aging and/or due to a repeated installation and removal of a first part of the reference device 4, a change results of the accuracy and thus the position and/or the alignment of the first part relative to a further part of the reference device 4. In that both the first part and the at least one further part of the reference device 4 have at least one reference pattern 5, 5′, a comparison and/or a matching of the position and/or alignment of these reference patterns 5, 5′ relative to one another and a comparison of this information with predefined target information describing the target status or the target position and/or target alignment of the two components of the reference device 4 and thus the two reference patterns 5, 5′ can be performed. If the actual status thus determined deviates from the target status beyond a defined degree, notification and/or error information can be output. An aging-related change of the reference device 4 can thus be ascertained.

Finally, the disclosure comprises an arrangement comprising a test part 2 and a reference device 4 as well as an augmented reality system 1, wherein the arrangement is configured to perform a method described herein.

### List of reference signs

1 augmented reality system
2 test part
3 receptacle section of 4
4 reference device
5 first reference pattern
5′ second reference pattern
6 image information
7 output unit
8 depth
9 first depth region of 5
10 second depth region of 5
11 third depth region of 5
12 first distance between 9 and 10
13 second distance between 10 and 11
14 third distance between 9 and 11

1.-11. (canceled)

12. A method for carrying out a test assembly of a test part to be mounted on a vehicle body, comprising:
mounting the test part on a receptacle section of a reference device;
detecting at least one reference pattern arranged or formed in or on the reference device using a detection device of an augmented reality system and generating reference pattern detection information; and,
generating image information, wherein the image information depends on the reference pattern information, the image information describes a predefined target status of the test part and a target alignment and/or target position of the test part relative to the reference device, and is output as visually perceptible information on an output unit of the augmented reality system.

13. The method according to claim 12, wherein the image information describes a target status of the reference device.

14. The method according to claim 12, wherein at least one reference pattern is used, which is formed as an element present separately from the reference device and is fastened or fastenable on the reference device in a friction-locked and/or materially-bonded and/or formfitting manner.

15. The method according to claim 12, wherein at least one reference pattern is used, which is integrally formed with the reference device as a depression and/or as a protrusion.

16. The method according to claim 12, wherein at least one reference pattern is used, the area of which is at least 2 cm².

17. The method according to claim 12, wherein at least one reference pattern is used, the area of which is at most 1000 cm².

18. The method according to claim 12, wherein at least one reference pattern is used, which has an optically detectable structure for detecting by the detection device and for generating the image information, which has an accuracy of at least 1.0 mm.

19. The method according to claim 12, wherein at least one reference pattern is used, the depth of which is at most 20 mm, and/or the depth of which is at least 0.25 mm.

20. The method according to claim 12, wherein at least one reference pattern is used, which comprises at least three defined depth regions, wherein a first depth region has from a second depth region and/or a second depth region has from a third depth region a distance of 0.5 mm to 100 mm.

21. The method according to claim 12, wherein a first reference pattern is arranged or formed on a first part of the reference device, a second reference pattern is arranged or formed on a second part of the reference device, the first and the second reference patterns are detected by way of the detection device of the augmented reality system, an evaluation of the position and/or alignment of the first reference pattern relative to the second reference pattern is performed, and reference pattern status information describing the position and/or alignment of the first reference pattern relative to the second reference pattern is generated.

22. An arrangement comprising a test part, a reference device, and an augmented reality system, wherein the arrangement is configured to perform a method according to claim 12.
